(19) United States
(12) Patent Application Publication
(10) Pub. No.: US 2005/0002360 A1
(43) Pub. Date: Jan. 6, 2005

(54) Method of and apparatus for communication via multiplexed links

(76) Inventors: Rene Lamontagne, Gatinoau (CA); Shiquan Wu, Nepean (CA)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(21) Appl. No.: 10/484,701

(22) PCT Filed: Jul. 17, 2002
(86) PCT No.: PCT/CA02/01119

(30) Foreign Application Priority Data
Jul. 26, 2001 (CA) 2,354,196

(51) Int. Cl. H04B 7/216

(52) U.S. Cl. 370/335; 370/342

(57) ABSTRACT

A communication structure and method which allows connection-like and connectionless communications to be provided on a multiplexed link is provided. The structure and method can make efficient use of available transmission capacity and/or network resources while providing both types of communication and hybrids. Connection-like communications can be provided by a dedicated code division multiplexed channels having allocated transmission capacity dedicated to the communication while connectionless communication can be provided by a shared orthogonal frequency division multiplexed channel through which data can be transmitted to subscribers. In an embodiment, the shared channel transmits inverse fast fourier transformed frequency sub-bands allocated to one or more of the subscribers. The allocation of the sub-bands can be fixed, or dynamically quantized or proportional.

### FIELD OF THE INVENTION

The present invention relates to a method of and apparatus for communication, and is particularly concerned with transmitting data, which can include both voice data and non-voice data, via a multiplexed link.

### BACKGROUND OF THE INVENTION

Many communications systems are known. Early communications systems were connection-based, in that a connection was physically established through the system between the communicating nodes. For example, in the early versions of the public switched telephone network (PSTN), users were provided a point-to-point connection to other users through switchboards, switches and trunks. More recently, the PSTN has employed multiplexed lines that are shared, through at least some part of the network, by multiple users, but which still provide a fixed amount of bandwidth and network capacity to each user for their connection, these bandwidth and network capacities being selected as meeting the anticipated maximum requirements for a common telephone voice conversation, typically referred to as toll quality.

Data communications systems have also been built which are connectionless. Connectionless systems generally operate on a best effort and/or statistical basis to deliver data via a suitable, but not necessarily fixed, route between the users, at best effort transmission rates and/or error rates. An example of a connectionless system is a packet network such as the Internet wherein the network capacity is shared amongst the users.

More recently, attempts have been made to combine connectionless and connection-like services in a single communication system. For example, much interest has been expressed recently in voice over IP (VoIP) through the Internet. However, it has proven difficult and/or costly to create a communication system which can meet both the connection-like requirements of VoIP (utilizing a moderate data rate and having some tolerance for errors, but requiring low latency) and connectionless data (often utilizing a high, bursty data rate and having a relatively high tolerance to latency but little tolerance for errors).

Attempts have been made to provide a connection-like mechanism via the Internet. One such attempt is the ReSerVation (RSVP) Protocol proposed by some vendors and which allows network capacity to be “reserved” at routers and switches to establish a “virtual” connection through the Internet to better ensure that desired quality of service (QoS) levels will be met for the virtual connection. However, support for RSVP must explicitly be implemented within an application and at each switch and/or router involved in the virtual connection, which has been difficult to achieve to date. Further, there is a significant amount of time and overhead required to set up an RSVP connection which can negate the benefits of an RSVP connection for connections of relatively short duration. Even when implemented, RSVP does not typically result in an efficient usage of network capacity as the maximum anticipated bandwidth and/or network capacity requirements must be reserved for the duration of the connection, even if they are not used, or are not used continuously. Thus, in many circumstances, reserved network resources are sitting idle, or are under utilized, for some portion of time. Further, RSVP does not include any incentive mechanism by which applications/users are encouraged to only make effective use of network resources, i.e.—unreasonable requests for resources can be made by a user or application as there are no economic or other disincentives for doing so.

Such difficulties are exacerbated when the links on which the network, or a portion of the network, is implemented involve a multiplexed link of expensive and/ or limited bandwidth. In such cases efficient utilization of bandwidth and/or network resources is very important and RSVP or similar strategies have difficulty in meeting desired efficiencies. As used herein, the term multiplex and/or multiplexed link are intended to comprise any system or method by which a link is shared amongst users. Examples of such multiplexed links include wired or wireless links employing multiplexing systems such as TDMA, CDMA, FDMA or other arrangements.

A specific prior art example of a communication system providing digital voice transmission over a multiplexed wireless link is a PCS (Personal Communication System) cellular system. Such systems can employ a multiplexing technique such as CDMA, TDMA, hybrid systems such as GSM, or other strategies to allow multiple callers to share the wireless link between the cellular base station and the PCS mobile units in both the upstream (mobile to base station) and downstream (base station to mobile) directions. One popular such system is the CDMA-based IS-95 cellular system in use in North America, South Korea and Japan.

More recently, so-called third generation wireless proposals have been developed by groups interested in providing higher data rates for wireless communications. One such group is the 3^{rd} Generation Partnership Project (3GPP). The 3GPP have been working to extend the work done on the Global System for Mobile communication (GSM) to extend the radio access technologies, Universal Terrestrial Radio Access (UTRA) for both frequency division duplex (FDD) and time division duplex (TDD) modes. The FDD and TDD modes are to be used on a cell basis, that is a given cell is either operating in an FDD mode or a TDD mode.

It is therefore desired to have a communications apparatus and method of providing data communications, including voice data, over wireless or other multiplexed links.

### SUMMARY OF THE INVENTION

It is an object of the present invention to provide a method of and apparatus for communication via a multiplexed link.

According to an aspect of the present invention, there is provided a communications structure for communicating between at least one network node and at least two subscriber stations through a multiplexed link, said structure comprising a plurality of code division multiple access (CDMA) channels, each channel having allocated to it a portion of the transmission power budget of said link to provide communication between said network node and one of said at least two subscriber stations and a shared orthogonal frequency division multiplex (OFDM) channel having allocated to it a portion of the transmission power budget of said link, said shared channel providing a plurality of sub-bands for transmission of data from said network node to said at least two subscriber stations, whereby the shared OFDM channel, providing a relatively high data rate, overlaps the CDMA channels to maintain compatibility therewith.

According to another aspect of the present invention, there is provided a method of communicating between at least one network node and at least two subscriber stations through a multiplexed link, said method comprising the steps of while maintaining a dedicated code division multiplexed communications channel to each of said at least two subscriber stations, monitoring demand for transmission of data from said network node to any of said at least two subscriber stations and responsive to determining such demand, allocating at least one sub-band of a shared orthogonal frequency division multiplexed channel providing a plurality of sub-bands for transmission of data from said network node to said at least two subscriber stations to one subscriber station.

According to yet another aspect of the present invention, there is provided a communications network comprising at least two subscriber stations, and a base station having means for maintaining a dedicated code division multiplexed communications channel to each of said at least two subscriber stations, means for monitoring demand for transmission of data from said network node to any of said at least two subscriber stations; and means, responsive to determining such demand, allocating at least one sub-band of a shared orthogonal frequency division multiplexed channel providing a plurality of sub-bands for transmission of data from said network node to said at least two subscriber stations to one subscriber station.

According to a further aspect of the present invention, there is provided a method of communicating between at least one network node and at least two subscriber stations through a multiplexed link, said method comprising the steps of monitoring service requests from the at least two subscriber stations and responsive to a request providing one of a dedicated code division multiplexed communications channel to each of said at least two subscriber stations, a shared orthogonal frequency division multiplexed channel and while maintaining a dedicated code division multiplexed communications channel to each of said at least two subscriber stations, monitoring demand for transmission of data from said network node to any of said at least two subscriber stations, and responsive to determining such demand, allocating at least one sub-band of a shared orthogonal frequency division multiplexed channel providing a plurality of sub-bands for transmission of data from said network node to said at least two subscriber stations to one subscriber station.

The present invention provides a communication apparatus for and method of connection-like and connectionless communications on a multiplexed communication link. The apparatus and method can make efficient use of available bandwidth and/or network resources while providing both types of communication. Connection-like communications can be provided by a shared channel having allocated power dedicated to the communication while connectionless communication can be provided by allocating portions of a frequency band that is allocated a portion of the power budget for the communications link. In an embodiment, the frequency band is divided into sub-bands also known as bins and the bins are allocated on a demand basis. Orthogonal Frequency Division Multiplexing.(OFDM) is used to transmit data to the users who have been allocated one or more sub-bands.

### BRIEF DESCRIPTION OF THE DRAWINGS

Preferred embodiments of the present invention will now be described, by way of example only, with reference to the attached Figures, wherein:

FIG. 1 illustrates a wireless local loop system employing a multiplexed radio link;

FIG. 2 illustrates a known communications system channel structure;

FIG. 3 illustrates downlink physical channels in accordance with an embodiment of the present invention;

FIG. 4 illustrates an OFDM symbol in the frequency domain for the OFDM channel of FIG. 3;

FIG. 5 illustrates an OFDM symbol in the time domain for the OFDM channel of FIG. 3;

FIG. 6 illustrates an OFDM system architecture with space-time transmit diversity (STTD) in accordance with an embodiment of the present invention;

FIG. 7 illustrates an training symbol in the frequency domain for both channel A and B of FIG. 6;

FIG. 8 illustrates apparatus for transmitting data multiplexed according to the method of FIGS. 6 and 7 together with other data in accordance with an embodiment of the present invention; and

FIG. 9 illustrates apparatus for receiving the data multiplexed according to the method of FIGS. 6 and 7.

### DETAILED DESCRIPTION OF THE INVENTION

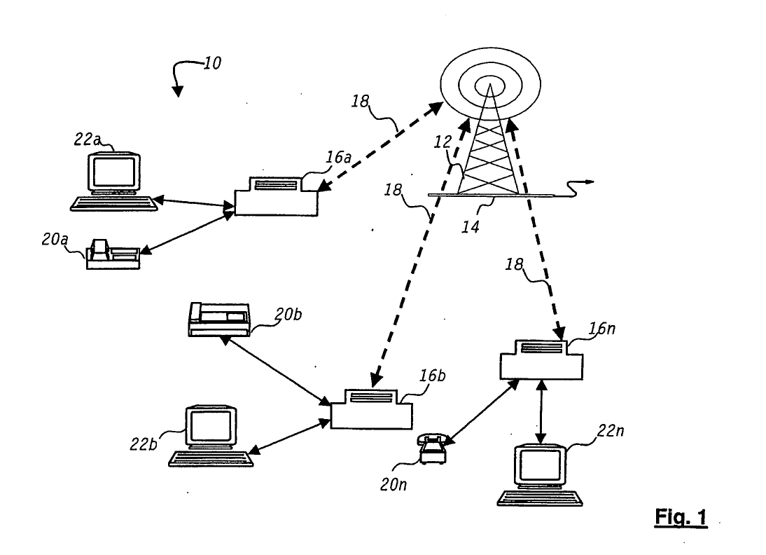

Referring to FIG. 1, there is illustrated a wireless local loop (WILL) system, indicated generally at 10. System 10 includes at least one network node, such as base station 12, which is connected to one or more networks, such as the PSTN and/or the Internet, and/or to one or more other base stations 12, via a back haul 14. Each base station 12 communicates with a plurality of subscriber stations 16 via a multiplexed radio link 18 shared between subscriber stations 16a-n. In FIG. 1, each subscriber station 16 can provide simultaneous connections to at least one telephony device 20, such as a telephone set or facsimile machine, and a data device 22 such as a computer or video conferencing system.

Radio link 18 employs a suitable multiplexing technique, such as TDMA, FDMA, CDMA, hybrids thereof or other multiplexing techniques to allow simultaneous use of radio link 18 by more than one subscriber station 16 and/or base station 12.

In prior art systems where, for example, subscriber stations are mobile telephones, a base station can assign the usage of a portion of a radio link to a subscriber station, on an as-needed basis. For example, in a system employing IS-95, the radio link is divided into a sixty-four channels in the forward link from the base station to the subscriber station. Some of these channels are dedicated for control and signaling purposes between the base station and subscriber stations, and the balance form a pool of traffic channels, one or more of which can be assigned as needed, to communicate with a subscriber station.

The IS-95 communication system suffers from certain disadvantages. For example, the channels are of fixed pre-selected data rate (e.g., 9.6 or 14.4 kilobits per second) and use of a traffic channel is reserved for the duration of the connection, even if the connection is not currently using the link resources (bandwidth and/or code space) allocated to the channel. It is not unusual that a voice conversation includes relatively long pauses wherein no information is transmitted and channel bandwidth is essentially wasted (although in CDMA, this results in a desirable reduction in interference between users).

When connectionless services are considered, this problem is much worse as transmissions to a data device, such as a computer, can comprise one or only a few packets that typically arrive in bursts, rather than at a steady rate. A channel established for such a connectionless service will therefore typically not use a large part of its allocated link resources, yet these unused resources are reserved for the duration of that connection and are unavailable for use elsewhere in the system until the channel is freed. In addition, there is a relatively significant overhead required to assign a channel between a base station and a subscriber station.

Thus, for connectionless services between a base station and a subscriber station, the time and/or network processing requirements for establishing a channel can be unreasonable for short bursts of packets.

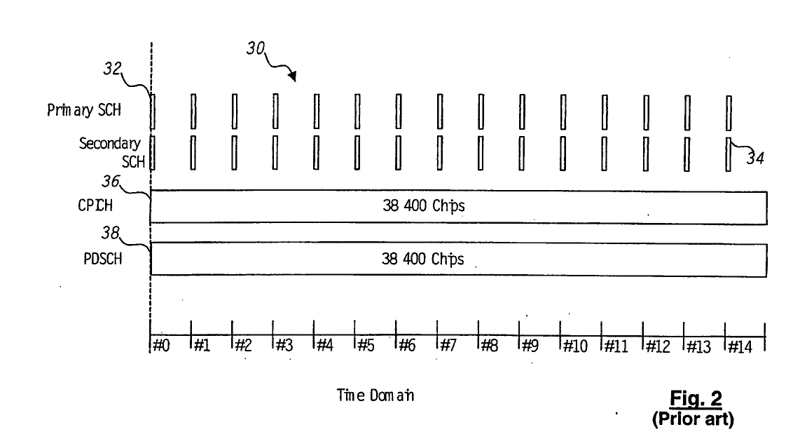

Referring to FIG. 2, there is illustrated a known downstream (from base station to users) channel structure for 3GPP UTRAN, FDD mode. The downlink channels 30 are shown for a 10 ms period. The downlink channels 30 include primary and secondary synchronization channels (SCH) 32 and 34, a common pilot channel (CPICH) 36, and a physical downlink shared channel (PDSCH) 38. A complete specification of the physical channels for 3GPP FDD is provided in 3GPP TS 25.211 V4.0.0 (2001-03) Technical Specification Group Radio Access Network; Physical channels and mapping of transport channels onto physical channels (FDD) (Release 4). This specification and other technical specifications for 3GPP™ can be downloaded from the website: www.3gpp.org.

The proposed 3GPP Universal Terrestrial Radio Access (UTRA) in frequency division duplex mode (PDD) provides for various rates of data transmission. In order to transmit at the higher data rates, the spreading factor must be reduced. Unfortunately, a lower spreading factor means that the inter-symbol interference portion of the received signal, in a multi-path environment does not cancel out, as is the case with a higher spreading factor. Consequently, the use of a low spreading factor effectively defeats one of the main benefits normally associated with using CDMA. Hence, at higher data rates intersymbol interference (ISI) becomes problematic.

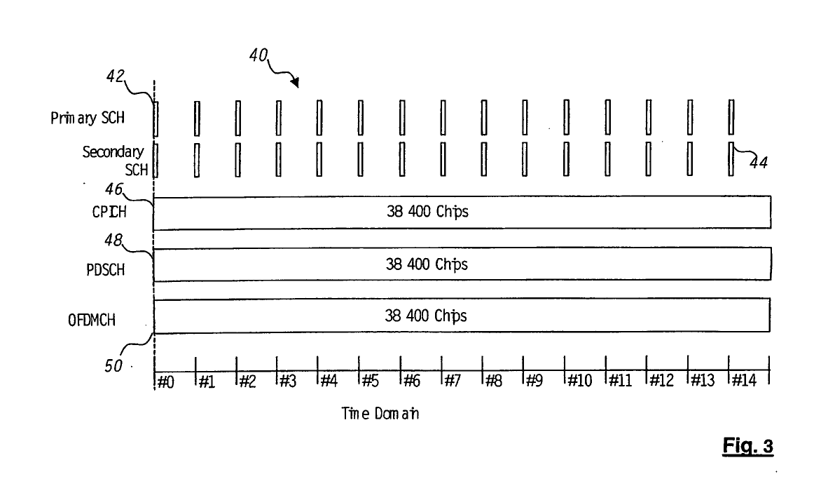

Referring to FIG. 3 there are illustrated downlink physical channels in accordance with an embodiment of the present invention. The downlink channels 40 are shown for a 10 ms period. The downlink channels 40 include primary and secondary synchronization channels (SCH) 42 and 44, a common pilot channel (CPICH) 46, a physical downlink shared channel (PDSCH) 48, and an orthogonal frequency division multiplex channel (OFDMCH) 50.

The downlink channels 40 are shown for a 10 ms period, as with the 3GPP UTRAN, FDD mode of FIG. 2, the downlink channels 40 include primary and secondary synchronization channels (SCH) 42 and 44, the common pilot channel 46, and physical downlink shared channel (PDSCH) 48. In addition, orthogonal frequency division multiplex channel (OFDMCH) 50 is added. The OFDMCH 50 uses orthogonal frequency division multiplexing (OFDM). From a total broadcast power budget, power is allocated in dependence upon relative traffic from data versus other channels, between the OFDMCH 50 and the PDSCH 48.

In operation of the wireless network of FIG. 1, in accordance with an embodiment of the present invention the OFDMCH 50 is combined with the other downlink channels as described in detail herein below. In order to overlay the OFDMCH 50 on the PDSCH 48, a low spreading factor is used, typically of 64 or less. To the PDSCH 48, the OFDMCH50 looks like noise, and can be received provided sufficient signal-to-noise is available.

While the present embodiment has been described in terms providing the OFDMCH50, a practical system based on the present embodiment would include the ability to respond to subscriber requests either by providing the OFDMCH 50 only, the OFDMCH 50 overlaid on the PDSCH 48 or the PDSCH 48. The combined OFDMCH 50 and PDSCH 48 provide both the capability of providing high-speed data while maintaining compatibility with 3GPP FDD for voice and low-speed data, while avoiding the ISI problems associated with a high data rate using just the PDSCH 48.

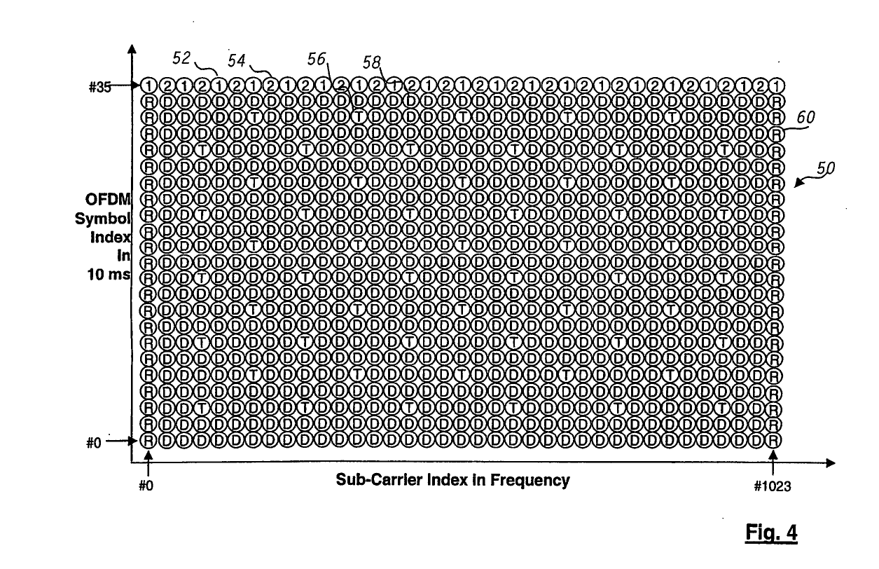

Referring to FIG. 4 there are illustrated OFDM symbols in the frequency domain for the OFDM channel of FIG. 3. The OFDMCH symbols are converted into chips by inverse fast Fourier transform (IFFT), there being 36 1K-OFDM symbols within each 10 ms timeframe. The OPDMCH 50 has a configurable number of slots from 1 to 35 for each user assignment (with 36 being occupied by pilot) and is time multiplexed with other channels for transmission. One OFDM channel frame 50 includes chips designated for Tx1 and Tx2 pilots 52 and 54, transmitter parameter signaling (TPS) 56, data 58 and reserved 60. Different users can be separated either by different subcarrier groups and time slots, or by Wash code cover in frequency domain. Each OFDM symbol has 1024 sub-carriers with a sub-carrier separation 3.84 MHz/1024=3.75 kHz. Table A provides a legend for FIG. 4:

TABLE A

| Reference Char | Symbol | Represents |
|---|---|---|
| 52 | [symbol] | Tx1 Pilot |
| 54 | [symbol] | Tx2 Pilot |
| 56 | [symbol] | TPS |
| 58 | [symbol] | Data |
| 60 | [symbol] | Reserved |

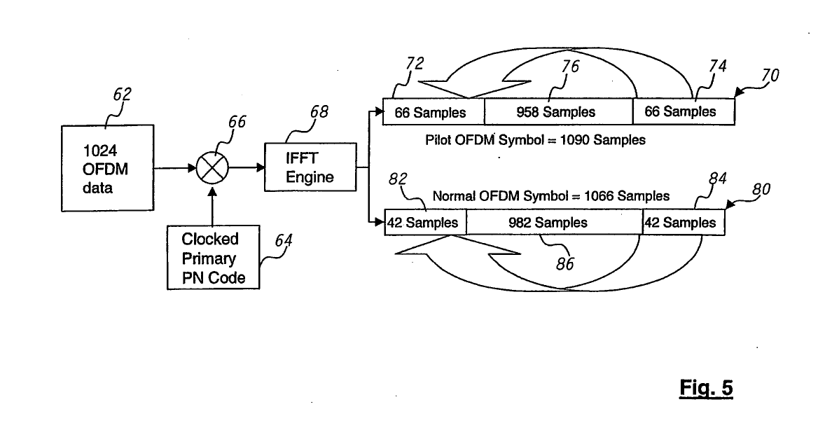

Referring to FIG. 5 there is illustrated an OFDM symbol in the time domain for the OFDM channel of FIG. 3. Each bin of 1024 chips of data as represented by a block 62 is multiplied by a clocked primary pseudo-random code 64 at 66 and applied as input to an inverse fast Fourier transform (IFFT) engine 68 to provide either a pilot OFDM symbol 70 (if pilot data provided) or a normal data OFDM symbol 80. The pilot OFDM symbol 70 includes a preamble 72 of 66 samples copied from the last 66 samples 74 of the 1024 data samples with the first 958 samples 76 there between. The normal OFDM symbol 80 includes a preamble 82 of 42 samples copied from the last 42 samples 84 of the 1024 data samples with the first 982 samples 86 there between. The preamble is chosen to account for delay spread within the system 10. Each normal OFDM symbol has 42 chips prefix to cover 11 ms delay spread and each pilot OFDM symbol has 66 chips prefix.

In operation, connectionless data to be sent to a subscriber station 16 is sent on the OFDMCH 50. The bins or slots are allocated in dependence upon demand to send such data to the subscriber stations 16a-n. Hence, one subscriber, for example the subscriber station 16a may, during a 10 ms time period, have no data waiting to be sent and is therefore not allocated any bins. While a second subscriber, e.g., the subscriber station 16b may have twice as much data as a third subscriber, e.g. the subscriber station 16n. In this example, if these were the only two subscribers that were to receive connectionless data, two-thirds of the slots would be allocated to the subscriber station 16b while the remaining one-third was allocated to the subscriber station 16n. In this manner, the bandwidth of the broadcast data channel is allocated on the basis of need. Dynamic allocation of the bins could, for example be based upon simple metrics such as buffer occupancy. This is a very simple example of how the bins could be allocated, clearly one of ordinary skill in the art would know or could devise more complex algorithms for allocating the bins between subscribers.

Once the bins are allocated, for a given 10 ms time period, the data is converted from the frequency domain to the time domain by the IFFT engine 68. The orthogonal frequency domain multiplexing OFDM allows the chips being transmitted to be closely spaced, yet recoverable at the subscriber station 16 without the use of complex channel equalization. This is due to the shape of the spectrum for each sample in the time domain.

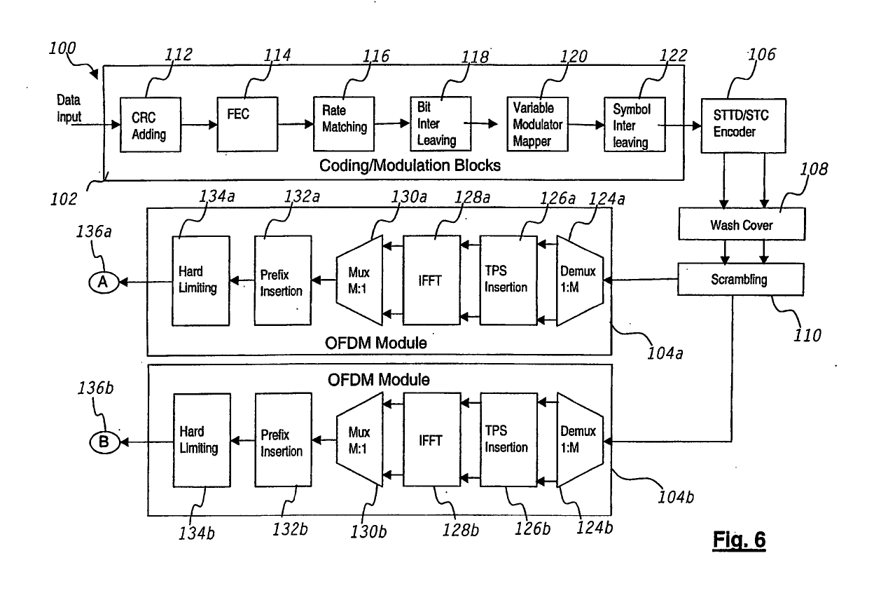

Referring to FIG. 6 there is illustrated a method of multiplexing data in accordance with an embodiment of the present invention. The method 100 includes coding and modulating 102, and orthogonal frequency division modulating 104.

Coding and modulating 102 includes the steps of CRC adding 112, forward error correction (FEC) 114, rate matching 116, bit interleaving 118, variable modulator mapping 120, and symbol interleaving 122.

Orthogonal frequency division modulating 104 includes 1:M demultiplexing 124, transmitter parameter signaling inserting 126, inverse fast Fourier transforming 128, 1:M multiplexing 130, prefix inserting 132, hard limiting 134, and outputting a time domain signal 136.

Between the coding/modulating 102 and the orthogonal frequency division modulating 104 there are additional steps of STTD/STC encoding 106, Wash covering 108 and scrambling 110.

TPS (transmitter parameter signaling) is reserved for upper layer signaling purposes. Each subscriber station 16 decodes these TPS first to know which sub-carriers/slots belong to it. Each of the two branches outputs a time domain complex data vector of dimension 35×(1024+42)=37310 that will go to a channel combination block.

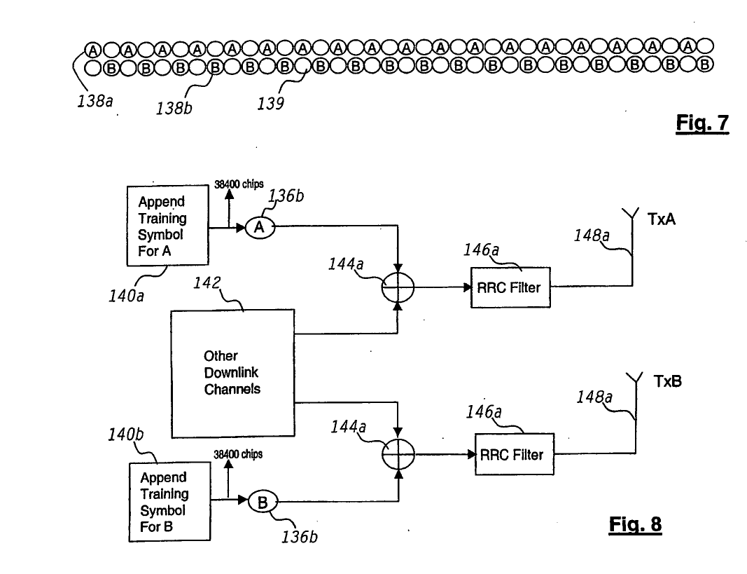

Referring to FIG. 7 there is illustrated an OFDM training symbol in the frequency domain for the OFDM channel of FIG. 3. The OFDM training symbol is the first of 36 OFDM symbols of each 10 ms frame. In FIG. 6, the first OFDM symbol of each 10 ms frame is not included. This OFDM symbol is a known training symbol and is used for system acquisition channels estimation purposes. Mobility can be handled by inserting more training symbols. This OFDM symbol is converted into 1024+66=1090 chips (Refer to FIG. 5) and there is no wash cover for these known sequences, but they are scrambled according to the predetermined scrambling sequence. The OFDM training symbol includes a known symbol for TxA 138a, a known symbol for TxB 138b and a null element 139.

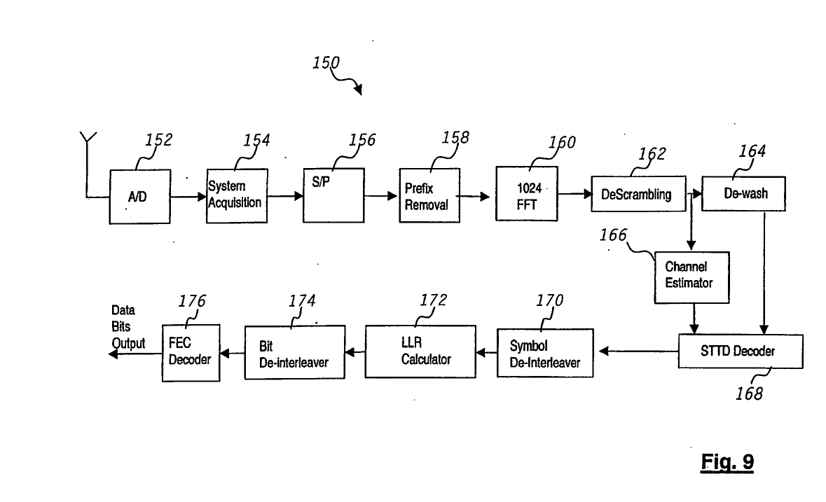

Referring to FIG. 8 there is illustrated channel combination block for transmitting data multiplexed according to the method of FIGS. 6 and 7 together with other data in accordance with an embodiment of the present invention. The channel combination block accepts as input, outputs 136a and 136b from the OFDM method of multiplexing 100, appends the training symbols as represented by blocks 140a for training symbol A and 140b for training symbol B and from other channels 142 and combines them at 144a and 144b, passes them through standard root raised cosine (RRC) filters 146a and 146b, respectively to antennae 148a and 148b for transmission.

Referring to FIG. 9 there is illustrated apparatus for receiving the data multiplexed according to the method of FIGS. 6 and 7. The receiver 150 includes an analog to digital converter 152, a system acquisition block 154, a symbol/pilot differentiator 156, a prefix removal block 158, a fast Fourier transform block 160, a de-scrambler 162, a de-wash block 164, a channel estimator 166, a STD decoder 168, a symbol de-interleaver 170, an LLR Calculator 172 a bit de-interleaver 174, a forward error correction decoder 176 and an output 178. FIGS. 7 and 9 illustrate only the transmission and reception of the OFDM channel. The processing of other channels such as Primary SCH, Secondary SC, CPICH, and PDSCH are as provided by the evolving 3GPP standard. In the receiver 150, OFDM-BDCH decoding reverses the process in the transmitter. An accurate channel estimation is achieved by using the predetermined known sequence of FIGS. 7 and 8.

The above-described embodiments of the invention are intended to be examples of the present invention and alterations and modifications may be effected thereto, by those of skill in the art, without departing from the scope of the invention, which is defined solely by the claims appended hereto.

1. A communications structure for communicating between at least one network node and at least two subscriber stations through a multiplexed link, said structure comprising:
a plurality of code division multiple access (CDMA) channels, each channel having allocated to it a portion of the transmission power budget of said link to provide communication between said network node and one of said at least two subscriber stations; and
a shared orthogonal frequency division multiplex (OFDM) channel having allocated to it a portion of the transmission power budget of said link, said shared channel providing a plurality of sub-bands for transmission of data from said network node to said at least two subscriber stations;
whereby the shared OFDM channel, providing a relatively high data rate, overlaps the CDMA channels to maintain compatibility therewith.

2. A structure as claimed in claim 1 wherein one sub-band of said plurality of sub-bands is allocated for data communication to one of said at least two subscriber stations.

3. A structure as claimed in claim 2 wherein said one sub-band is allocated in dependence upon demand for data communication to one of said at least two subscriber stations.

4. A structure as claimed in claim 3 wherein demand is assessed during a predetermined time interval.

5. A structure as claimed in claim 4 wherein the time interval is 10 ms.

6. A structure as claimed in claim 1 wherein said shared orthogonal frequency division multiplexed channel includes said plurality of sub-bands and each sub-band includes a plurality of chips.

7. A structure as claimed in claim 6 wherein said plurality of sub-bands includes 36 sub-bands.

8. A structure as claimed in claim 7 wherein said plurality of chips includes 1024 chips.

9. A method of communicating between at least one network node and at least two subscriber stations through a multiplexed link, said method comprising the steps of:
while maintaining a dedicated code division multiplexed communications channel to each of said at least two subscriber stations, monitoring demand for transmission of data from said network node to any of said at least two subscriber stations; and
responsive to determining such demand, allocating at least one sub-band of a shared orthogonal frequency division multiplexed channel providing a plurality of sub-bands for transmission of data from said network node to said at least two subscriber stations to one subscriber station.

10. A method as claimed in claim 9 wherein the step of monitoring include the step of determining data bit queue length for each subscriber terminal.

11. A method as claimed in claim 9 wherein the step of allocating includes allocating sub-bands in proportion to the demand.

12. A method as claimed in claim 11 wherein the step of allocating includes the steps of distributing a subset of sub-bands to each subscriber station and allocating remaining sub-bands in proportion to the demand.

13. A communications network comprising:
at least two subscriber stations; and
a base station having means for maintaining a dedicated code division multiplexed communications channel to each of said at least two subscriber stations, means for monitoring demand for transmission of data from said network node to any of said at least two subscriber stations; and means, responsive to determining such demand, allocating at least one sub-band of a shared orthogonal frequency division multiplexed channel providing a plurality of sub-bands for transmission of data from said network node to said at least two subscriber stations to one subscriber station.

14. A network as claimed in claim 13 wherein the means for monitoring includes a request queue.

15. A network as claimed in claim 14 wherein the means for allocating includes logic to determine how to service the request queue.

16. A method of communicating between at least one network node and at least two subscriber stations through a multiplexed link, said method comprising the steps of:
monitoring service requests from the at least two subscriber stations; and
responsive to a request providing one of:
(a) a dedicated code division multiplexed communications channel to each of said at least two subscriber stations;
(b) a shared orthogonal frequency division multiplexed channel; and
(c) while maintaining a dedicated code division multiplexed communications channel to each of said at least two subscriber stations, monitoring demand for transmission of data from said network node to any of said at least two subscriber stations; and responsive to determining such demand, allocating at least one sub-band of a shared orthogonal frequency division multiplexed channel providing a plurality of sub-bands for transmission of data from said network node to said at least two subscriber stations to one subscriber station.

17. A method as claimed in claim 16 wherein the step of monitoring include the step of determining data bit queue length for each subscriber terminal.

18. A method as claimed in claim 16 wherein the step of allocating includes allocating sub-bands in proportion to the demand.

19. A method as claimed in claim 18 wherein the step of allocating includes the steps of distributing a subset of sub-bands to each subscriber station and allocating remaining sub-bands in proportion to the demand.
